(19) United States
(12) Patent Application Publication
(10) Pub. No.: US 2004/0015887 A1
(43) Pub. Date: Jan. 22, 2004

(54) Simulation method, simulation system and simulation program for software and hardware

(75) Inventor: Makoto Kudo, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/102,884

(22) Filed: Mar. 22, 2002

(30) Foreign Application Priority Data
Apr. 6, 2001 (JP) 2001-107942(P)
Mar. 7, 2002 (JP) 2002-62576(P)

(51) Int. Cl. G06F 9/44

(52) U.S. Cl. 717/135; 703/22

(57) ABSTRACT

The invention provides a simulation method and the like which, where simulations of hardware and software that cooperatively operate with one another are conducted, can readily link software debugging functions to hardware simulation functions. At a first computer, a debugger is used to debut software, and generates commands for simulation of hardware and transmits the same to a second computer. At the second computer, the commands are received at an HDL simulator, and the commands are inputted in a bus interface model included in a hardware simulation model created in an HDL by using the HDL simulator, whereby hardware simulations are performed in cooperation with debugging of software.

### BACKGROUND OF THE INVENTION

1. Field of Invention

The present invention relates to a method and a system for simulating software and hardware that mutually cooperatively operate with one another, and more particularly to a simulation method and simulation system in which a debugger for software is linked to an HDL simulator for hardware, and debugging of the software and checking of the hardware design can be performed. Furthermore, the present invention relates to a recording medium that stores a simulation program that uses such a simulation method.

2. Description of Related Art

Generally, an apparatus in which a microcomputer is installed, such as a printer, for example, uses a microcomputer board that mounts thereon a CPU, a ROM that stores software, such as a program that is created in ‘C’ language or assembler to be used for operating the CPU, a RAM that temporarily stores data, and an ASIC including hardware, such as a logic circuit designed to meet the user's specification. In order to simulate an operation of such a microcomputer, the simulation should preferably be performed while linking the software and the hardware. Such simulation is called “co-simulation” (cooperative simulation) of the software and hardware.

FIG. 6 shows a composition of a conventional simulation program that is used in cooperative simulation. This program is formed of an execution program, in which a PLI (program language interface) section 61 created in ‘C’ language and having a function of debugging software, and an HDL (hardware description language) simulator section 62, are linked to one another. Also, a simulation model 63 for the ASIC, the ROM, the RAM and a bus interface (BUS I/F) to be mounted on the microcomputer board is created in HDL.

Debugger functions (including program execution, breakpoint, memory dump, graphical interface (GUI) and the like), and a command set simulator that operates in the same manner as a CPU core, are mounted on the PLI section 61. Where programs are executed at the PLI section 61, the HDL simulator section 62 also cooperatively operates and accesses ASIC models and the like through the bus interface to perform debugging of the programs and ASIC.

As described above, conventionally, a simulation program is designed such that the PLI section 61 can have as many functions as possible. However, in this case, the PLI section 61 needs to be modified to change linking with the simulator section 62 where a simulation program is under development, or even where a slight version-up is made in response to the user's request, which would result in an increase in the cost and time required for the simulation. Also, standardized specifications may be available for an HDL simulator used for the simulator section 62. However, details thereof are different from one company to another, and therefore it would take a substantial amount of time to modify the PLI section 61 to match a variety of HDL simulators.

Also, since the CPU core operates on the command set simulator in the PLI section 61, cycle-base timings of the actual machine and the simulation do not coincide with one another, which causes a problem of timing failure generation.

### SUMMARY OF THE INVENTION

Accordingly, in view of the above, it is an object of the present invention to provide a simulation method and a simulation system, which, where simulations of hardware and software that mutually cooperatively operate are conducted, can readily link debugging functions of the software to simulation functions of the hardware, and can simulate even with cycle-based timings, as well as a storage medium that stores a simulation program that uses such a simulation method.

To address the problems described above, a simulation method in accordance with the present invention is a method for simulating software and hardware that cooperatively operate with one another by an HDL (hardware description language) simulator complying with Verilog-HDL or VHDL. The simulation method includes: (a) in a first computer, debugging the software using a debugger, and generating a command to be used for simulation of the hardware; (b) in the first computer, transmitting the command generated in step (a) through a communication network; (c) in a second computer, receiving the command transmitted from the first computer at the HDL simulator; (d) in the second computer, simulating the hardware in cooperation with debugging of the software through inputting the command received in step (c) in a bus interface model included in a hardware simulation model created in HDL using the HDL simulator; and (e) in the second computer, transmitting from the HDL simulator data outputted from the bus interface model to the first computer through a communication network. Step (b) and step (e) perform a socket communication using a communication protocol of the Internet, and only functions of transmitting and receiving data train between the HDL simulator and the first computer are inputted in a PLI (program language interface) section that is later linkable to the HDL simulator, and processing of the data train is performed by the bus interface model.

Also, a simulation system in accordance with the present invention is a simulation system for simulating software and hardware that cooperatively operate with one another by an HDL (hardware description language) simulator complying with Verilog-HDL or VHDL. The simulation system includes: a first computer that debugs the software using a debugger, and generates and transmits through a communication network a command to be used for simulation of the hardware; a second computer that receives the command transmitted from the first computer at the HDL simulator, simulates the hardware in cooperation with debugging of the software through inputting the command received in a bus interface model included in a hardware simulation model created in HDL using the HDL simulator, and transmits from the HDL simulator data outputted from the bus interface model to the first computer through a communication network. The first and second computers perform a socket communication using a communication protocol of the Internet, and only functions of transmitting and receiving data train between the HDL simulator and the first computer are inputted in a PLI (program language interface) section that is later linkable to the HDL simulator, and processing of the data train is performed by the bus interface model.

A simulation program in accordance with the present invention is a program to be executed by a CPU for performing simulations of software and hardware that cooperatively operate with one another by an HDL (hardware description language) simulator complying with Verilog-HDL or VHDL. The program includes: (a) a program for receiving at the HDL simulator a command to be used for simulation of the hardware which is transmitted through a communication network from a computer that performs debugging of the software; (b) a program for simulating the hardware in cooperation with debugging of the software through inputting the command received in program (a) in a bus interface model included in a hardware simulation model created in HDL using the HDL simulator; and (c) a program for transmitting from the HDL simulator data outputted from the bus interface model to the computer that performs debugging of the software through a communication network. The computer that performs debugging of the software and the CPU perform a socket communication using a communication protocol of the Internet, and only functions of transmitting and receiving data train between the HDL simulator and the computer that performs debugging of the software are inputted in a PLI (program language interface) section that is later linkable to the HDL simulator, and processing of the data train is performed by the bus interface model.

Also, a storage medium in accordance with the present invention that stores a simulation program is a storage medium readable by a CPU for performing simulations of software and hardware that cooperatively operate with one another by an HDL (hardware description language) simulator complying with Verilog-HDL or VHDL. The program is provided for the CPU to execute (a) a program for receiving at an HDL simulator a command to be used for simulation of the hardware, the command being transmitted through a communication network from a computer that performs debugging of the software; (b) a program for simulating the hardware in cooperation with debugging of the software through inputting the command received in program (a) in a bus interface model included in a hardware simulation model created in HDL using the HDL simulator; and (c) a program for transmitting from the HDL simulator data outputted from the bus interface model to the computer that performs debugging of the software through a communication network. The computer that performs debugging of the software and the CPU perform a socket communication using a communication protocol of the Internet, and only functions of transmitting and receiving data train between the HDL simulator and the computer that performs debugging of the software are inputted in a PLI (program language interface) section that is later linkable to the HDL simulator, and processing of the data train is performed by the bus interface model.

In accordance with the present invention, the first computer performs debugging of software, generates various commands to simulate hardware, and transmit the same through a communication network; and the second computer uses a PLI (program language interface) to communicate with the first computer to thereby receive data, and uses an HDL simulator to simulate the hardware, whereby the load at the PLI section can be alleviated. Accordingly, the debugging functions for software and simulation functions for hardware can be readily linked to one another.

In any of the above aspects of the invention, the hardware simulation model may further include a CPU model for HDL simulation that performs an operation equivalent to a CPU, and a switching circuit model that supplies one of data outputted from the bus interface model and data outputted from the CPU model as input data in an external logic circuit model that corresponds to a memory or a logic circuit outside the CPU. Data from the external logic circuit model may be inputted to both of the CPU model and the bus interface model.

Also, the hardware simulation model may further include a command fetch control section that receives a command fetch signal from the CPU model, and controls stopping and resuming of an operation of the CPU model by switching to outputting or not outputting the command fetch signal to the external logic circuit according to a control signal.

Furthermore, the hardware simulation model may further include a ROM model that stores a program to be executed by the CPU model.

In accordance with this aspect of the invention, while a program is being executed by a debugger at the first computer, commands for only required sections may be generated, or the program may be directly executed by the CPU model at the second computer. In the case of the former, high-speed simulations can be performed, and in the case of the later, simulations can be performed at cycle-base timings.

### BRIEF DESCRIPTION OF THE DRAWINGS

FIG. 1 is a schematic of a composition of a simulation system in accordance with a first embodiment of the present invention;

FIG. 2 is a schematic of a composition of a simulation program that is used in the simulation system in accordance with the present embodiment;

FIG. 3 is a flow chart depicting an operation of the simulation system in accordance with the first embodiment of the present invention;

FIG. 4 is a schematic of a composition of a simulation program that is used in the simulation system in accordance with the second embodiment of the present invention;

FIG. 5 is a schematic of a composition of a simulation program that is used in the simulation system in accordance with the third embodiment of the present invention;

FIG. 6 is a schematic of a composition of a conventional simulation program.

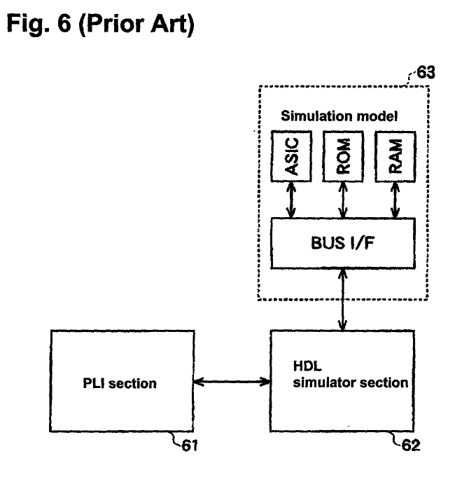

### DETAILED DESCRIPTION OF PREFERRED EMBODIMENTS

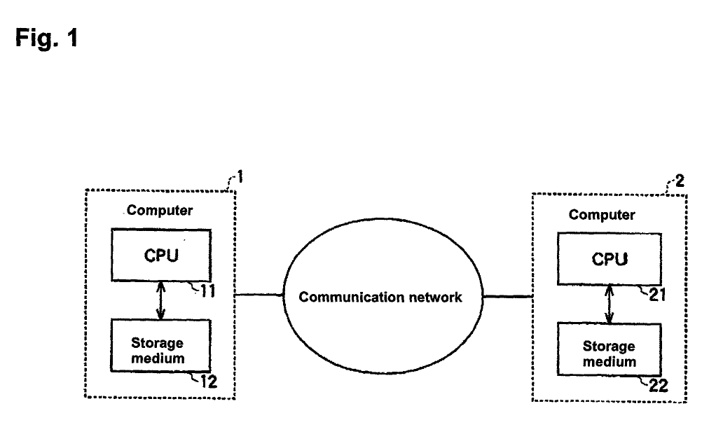

Embodiments of the present invention will be described below with reference to the accompanying drawings. It is noted that the same components will be indicated by the same reference numbers, and their description will not be repeated. FIG. 1 is a schematic of a composition of a simulation system in accordance with a first embodiment of the present invention. In the present embodiment, a description is provided as to a case in which simulations for a microcomputer board are conducted. The microcomputer board is equipped with a CPU, a ROM that stores software (a program for the microcomputer) that is created in ‘C’ language or assembler to be used for operating the CPU, a RAM that temporarily stores data, and an ASIC including hardware, such as a logic circuit designed to meet the user's specification.

In order to simulate such a microcomputer board, the simulation system in accordance with the present invention uses at least two computers that are connected to one another through a communication network, such as a public telephone network, the Internet, a LAN (local area network) or the like, as shown in FIG. 1. In the present embodiment, a socket communication, which uses TCP/IP that is a standard communication protocol in the Internet, is performed.

A first computer 1 includes a CPU 11 and a storage medium 12 that stores a simulation program, data and the like. Similarly, a second computer 2 includes a CPU 21 and a storage medium 22 that stores a simulation program, data and the like. The storage mediums 12, 22 correspond to a hard disk, flexible disk, MO, MT, RAM, CD-ROM, DVD-ROM, and the like.

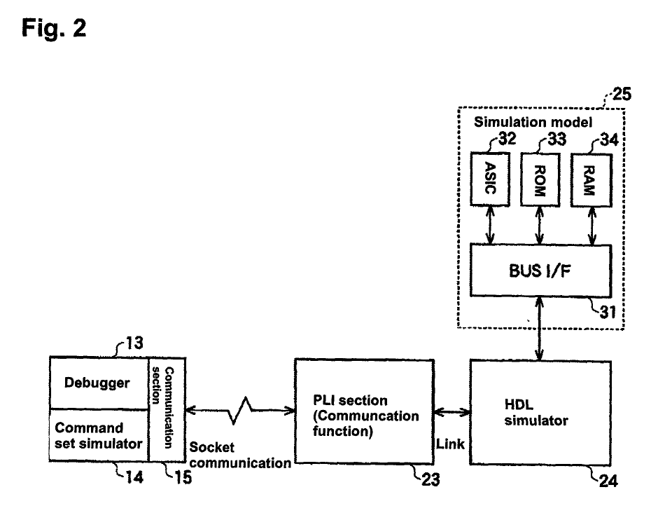

FIG. 2 is a schematic of a composition of a simulation program that is used in the simulation system in accordance with the present embodiment. The simulation program used at the first computer is created in a language such as ‘C’, and includes a debugger 13 having software debugging functions, a command set simulator 14 that operates in cooperation with HDL simulations and generates various command to be transmitted to an HDL simulator, and a communication section 15 that performs communication through a communication network. The debugger 13 has debugging functions, such as graphical user interface (GUI) to display debugging results in a display window, command processes to execute steps of a program for the microcomputer and the like. Also, the command set simulator 14 plays roles of a CPU, a ROM and a RAM on the microcomputer board.

The simulation program used at the second computer is created in a language, such as ‘C’, and uses one execution file in which a PLI (program language interface) section 23, that transmits and receives data through communicating with the first computer, is linked to an HDL simulator 24 that performs simulations by inputting data received from the first computer in a hardware simulation model that is created in a Verilog-HDL (hardware description language) or a VHDL.

A simulation model 25 includes an ASIC model 32, a ROM model 33, a RAM model 34, and a bus interface (BUS I/F) model 31 that communicate data with the HDL simulator 24, which correspond to hardware mounted on the microcomputer board.

In accordance with the present embodiment, the PLI section 23 of the simulation program executed at the second computer does not have debugging functions like those of the conventional software, and instead only controls open and close, and transmit and receive in the socket communication with the first computer that executes the debugger program. Also, interpretation of received commands and creation of data trains to be sent to the debugger 13 are performed by the bus interface model 31 that is created in an HDL. By this composition, even when the HDL simulator 24 is replaced, modifications of the PLI section 23 can be substantially reduced. Most of the corrections relate to sections of the bus interface model 31 created in an HDL and the debugger 13 that runs on an independent computer, and such corrections are readily made, and the number of development steps can be substantially reduced as a whole.

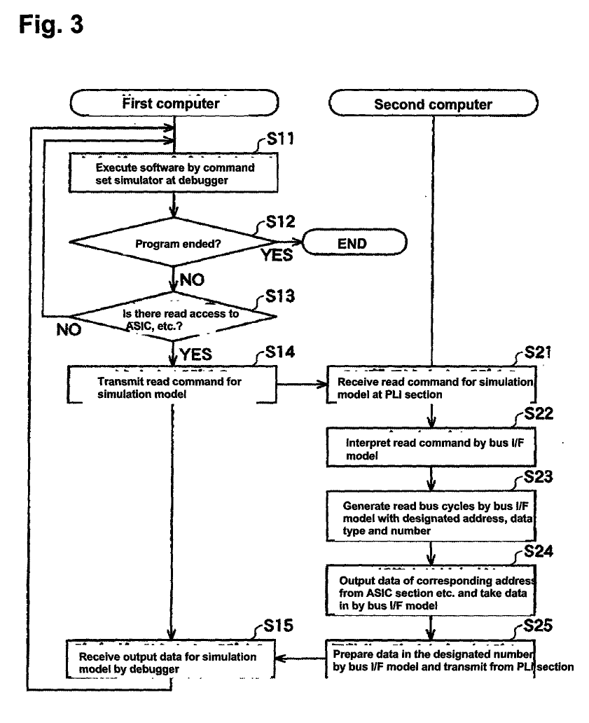

Next, an operation of the simulation system in accordance with the present embodiment will be described with reference to FIG. 2 and FIG. 3.

At the first computer, the debugger 13 operates the command set simulator to execute software (a microcomputer program) one command by one command, to thereby conduct data processing for the RAM, ROM and the like (step S11). In step S12, where the microcomputer program is completed, the simulation ends. In other cases, the process proceeds to step S13. A description is provided below as to a case where a command makes a read (read out) access to the ASIC.

In step S13, a determination is made as to whether or not a command that is currently executed needs a read access to the ASIC. Where a read access to the ASIC is not needed, the process returns to step S11, and the next command is executed. On the other hand, where a read access to the ASIC is needed, in step S14 to access the ASIC simulation model 32 created in an HDL, a read command is transmitted to the second computer through the communication network, using the communication section 15 that is included in the simulation program (step S14). It is noted that the read command includes data relating to an address of the ASIC to which a read access is made, data type and the number of data to be read out.

At the second computer, the read command is received at the PLI section 23 that is included in the simulation program (step S21). Further, the HDL simulator 24, that is linked to the PLI section 23, is used to supply the received read command to the bus interface model 31 that is included in the simulation model 25. The bus interface model 31 interprets the read command (step S22).

As described above, the read command designates an address value, a data type (for example, 8-bit, 16-bit, 32-bit or the like) and the number of data. In step S23, the bus interface model 31 generates read bus cycles in the designated address and data type in the designated number of data. In response, data of corresponding address is outputted from the ASIC model 32 included in the simulation model 25, and the bus interface model 31 takes in the data (step S24).

In step S25, the bus interface model 31 prepares data in the designated number, and the data are transmitted by the PLI section 23 from the second computer to the first computer through the communication network. At the first computer, the debugger receives the data (step S15). The received data are used to perform a command operation, and then it proceeds to the execution of the next command.

In this manner, hardware simulations are conducted in cooperation with debugging of the software.

In accordance with the present embodiment, the PLI section of the simulation program that is executed at the second computer can only be provided with simple functions of data transmission and reception, and therefore can be extremely readily transplanted in other HDL simulators, whereby the time period required to develop microcomputer boards or the like can be shortened. Also, the PLI section, once created, needs almost no version up, and version up of the bus interface model 31 is easy because it is created in an HDL. Accordingly, version up can be provided in a short period of time as a whole. Furthermore, since a debugger that is made for ICE can be readily applied to the debugger, the entire system can be developed with a lower number of steps and in a shorter period of time.

Next, a simulation system in accordance with a second embodiment of the present invention will be described. Where the command set simulator 14, that plays a role of a CPU on a microcomputer board, is used like in the first embodiment, its execution speed is fast, which is tens of thousands of commands per second, but simulations that time with the ASIC model and the like included in the simulation model 25 cannot be performed. Such a simulation is called a “command-precision simulation.”

On the other hand, where a CPU model, that can time on cycle base with the ASIC model and the like in the simulation model, is added, its execution speed is slow, which is several tens of commands per second, and its execution may not be possible depending on programs. Such a simulation is called a cycle-precision simulation.

In view of the above, the present embodiment provides one simulation model that can support both of the precisions.

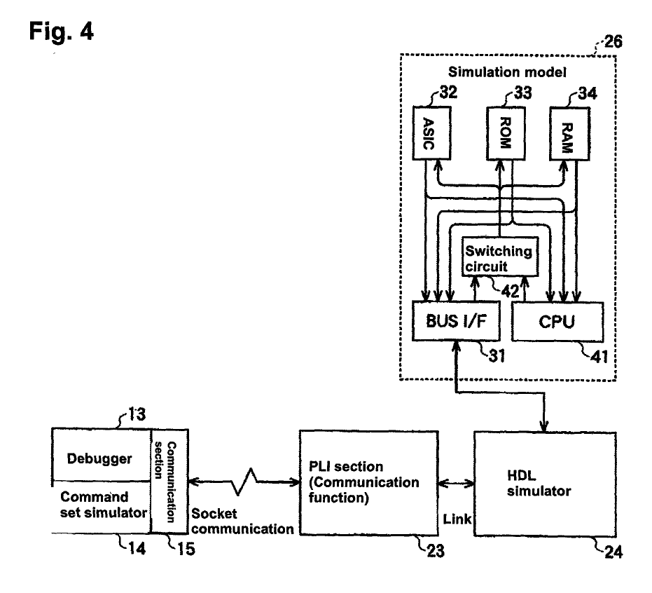

FIG. 4 is a schematic of a composition of a simulation program that is used in the simulation system in accordance with the present embodiment. A simulation model 26 of the present embodiment includes a CPU model 41 that performs operations equivalent on cycle base to those of a CPU on a microcomputer board. Where a high-speed execution is needed, a command set simulator 14 with a higher execution speed executes commands. Accesses are made to an ASIC through a bus interface, like the one shown in FIG. 2.

On the other hand, when it needs to time with an ASIC model or the like, the command set simulator 14 is not used, and instead the CPU model 41 executes commands stored in a ROM model 33 included in the simulation model 26 and performs operations equivalent on cycle base. Even where the CPU model 41 us used, and where a break takes place by a break point or the like, the operation is switched to the one performed through the bus interface, whereby debugging operations, such as memory dump, can be conducted from the debugger.

To perform such a switching operation described above, the simulation model 26 further includes a switching circuit model 42. The switching circuit model 42 selects one of data that is generated at the command set simulator 14 and outputted from the bus interface model 31 and data that is outputted from the CPU model 41, and supplies the same to the ASIC model 32, the ROM model 33, and the RAM model 34. On the other hand, data outputted from the ASIC model 32, the ROM model 33 and the RAM model 34 are supplied to both of the command set simulator 14 and the CPU model 41. Programs to be executed at the CPU model 41 are stored in the ROM model 33.

In accordance with the present embodiment, one type of simulation model is used, and multiple simulations with different speeds and different functions can be switched one for the other and can be used according to objectives. This can substantially enhance the efficiency in developing software and hardware where developing microcomputer boards or the like.

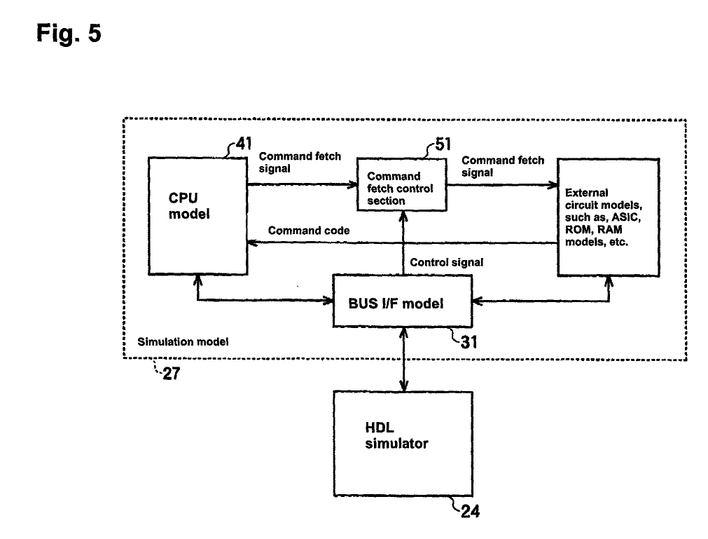

Next, a simulation system in accordance with a third embodiment of the present invention will be described with reference to FIG. 5. Where the CPU model 41 is used like in the second embodiment, possibilities exist that the operation of the CPU model 41 may change, or strange error operations may occur when the operation of the CPU model 41 is stopped or resumed. For this reason, a substantial amount of time is required to guarantee the quality of the simulation. Accordingly, in accordance with the present embodiment, stopping and resuming the operation of the CPU model 41 are made to be readily controllable.

As shown in FIG. 5, a simulation model 27 is provided with a command fetch control section 51. The command fetch control section 51 receives a command fetch signal from a CPU model 41, and switches to outputting or not outputting the command fetch signal according to a control signal that is supplied from an HDL simulator 24 through a bus interface model 31. Where the command fetch control section 51 outputs the command fetch signal, command codes are supplied from external circuit models, such ASIC, ROM, RAM models or the like to the CPU model 41, whereby the CPU model 41 operates normally. On the other hand, where the command fetch control section 51 does not output the command fetch signal, command codes are not supplied from the external circuit models to the CPU model 41, where the operation of the CPU model 41 is stopped. In this manner, stopping and resuming the operation of the CPU model 41 can be controlled. Other aspects are the same as those of the second embodiment.

In accordance with the present embodiment, stopping and resuming the operation of the CPU model 41 can be readily controlled without modifying the design of the CPU model 41. In accordance with this operation, the simulation system in accordance with the second embodiment shown in FIG. 4 can be readily developed.

[Effects of the Invention]

As described above, in accordance with the present invention, where simulations of software and hardware that mutually operate in cooperation with one another are performed, software debugging functions can be readily linked to hardware simulation functions. Furthermore, since a command precision simulation and a cycle precision simulation can be supported by one simulation model, the period to develop software and hardware in developing microcomputer boards can be shortened, and development cost can be reduced.

What is claimed is:

1. A simulation method for simulating software and hardware that cooperatively operate with one another by an HDL (hardware description language) simulator complying with Verilog-HDL or VHDL, the simulation method comprising:
(a) in a first computer, debugging the software using a debugger, and generating a command to be used for simulation of the hardware;
(b) in the first computer, transmitting the command generated in the step (a) through a communication network;
(c) in a second computer, receiving the command transmitted from the first computer at the HDL simulator;
(d) in the second computer, simulating the hardware in cooperation with debugging of the software through inputting the command received in step (c) in a bus interface model included in a hardware simulation model created in HDL using the HDL simulator; and
(e) in the second computer, transmitting from the HDL simulator data outputted from the bus interface model to the first computer through a communication network, steps (b) and (e) performing a socket communication using a communication protocol of the Internet, and functions of transmitting and receiving data train between the HDL simulator and the first computer being inputted in a PLI (program language interface) section that is later linkable to the HDL simulator, and processing of the data train is performed by the bus interface model.

2. The simulation method according to claim 1, the hardware simulation model further including a CPU model for HDL simulation that performs an operation equivalent to a CPU, and a switching circuit model that supplies one of data outputted from the bus interface model and data outputted from the CPU model as input data in an external logic circuit model that corresponds to a memory or a logic circuit outside the CPU, data from the external logic circuit model being inputted to both of the CPU model and the bus interface model.

3. The simulation method according to claim 2, the hardware simulation model further including a command fetch control section that receives a command fetch signal from the CPU model and controls stopping and resuming of an operation of the CPU model by switching to outputting or not outputting the command fetch signal to the external logic circuit according to a control signal.

4. The simulation method according to claim 2, the hardware simulation model further including a ROM model that stores a program to be executed by the CPU model.

5. A simulation system for simulating software and hardware that cooperatively operate with one another by an HDL (hardware description language) simulator complying with Verilog-HDL or VHDL, the simulation system comprising:
a first computer that debugs the software using a debugger, and generates and transmits through a communication network a command to be used for simulation of the hardware;
a second computer that receives the command transmitted from the first computer at the HDL simulator, simulates the hardware in cooperation with debugging of the software through inputting the command received in a bus interface model included in a hardware simulation model created in HDL using the HDL simulator, and transmits from the HDL simulator data outputted from the bus interface model to the first computer through a communication network, the first and second computers performing a communication using a communication protocol of the Internet, and functions of transmitting and receiving data train between the HDL simulator and the first computer being inputted in a PLI (program language interface) section that is later linkable to the HDL simulator, and processing of the data train being performed by the bus interface model.

6. The simulation system according to claim 5, the hardware simulation model further including a CPU model for HDL simulation that performs an operation equivalent to a CPU, and a switching circuit model that supplies one of data outputted from the bus interface model and data outputted from the CPU model as input data in an external logic circuit model that corresponds to a memory or a logic circuit outside the CPU, data from the external logic circuit model being inputted to both of the CPU model and the bus interface model.

7. The simulation system according to claim 6, the hardware simulation model further including a command fetch control section that receives a command fetch signal from the CPU model and controls stopping and resuming of an operation of the CPU model by switching to whether or not the command fetch signal is to be outputted to the external logic circuit according to a control signal.

8. The simulation system according to claim 6, the hardware simulation model further including a ROM model that stores a program to be executed by the CPU model.

9. A program to be executed by a CPU for performing simulations of software and hardware that cooperatively operate with one another by an HDL (hardware description language) simulator complying with Verilog-HDL or VHDL, the program comprising:
(a) a program for receiving at the HDL simulator a command to be used for simulation of the hardware, the command being transmitted through a communication network from a computer that performs debugging of the software;
(b) a program for simulating the hardware in cooperation with debugging of the software through inputting the command received in program (a) in a bus interface model included in a hardware simulation model created in HDL using the HDL simulator; and
(c) a program for transmitting from the HDL simulator data outputted from the bus interface model to the computer that performs debugging of the software through a communication network, the computer that performs debugging of the software and the CPU performing a socket communication using a communication protocol of the Internet, and only functions of transmitting and receiving data train between the HDL simulator and the computer that performs debugging of the software being inputted in a PLI (program language interface) section that is later linkable to the HDL simulator, and processing of the data train being performed by the bus interface model.
